(19) United States
(12) Patent Application Publication
(10) Pub. No.: US 2026/0203815 A1
(43) Pub. Date: Jul. 16, 2026

(54) SYSTEM FOR PREDICTING FOREIGN EXCHANGE TRANSACTIONS

(71) Applicant: JPMorgan Chase Bank, N.A., NEW YORK, NY (US)

(72) Inventor: Roberto Nicolas Savinelli, Almagro (AR)

(73) Assignee: JPMorgan Chase Bank, N.A., NEW YORK, NY (US)

(21) Appl. No.: 19/017,075

(22) Filed: Jan. 10, 2025

(51) Int. Cl. G06Q 40/04; G06Q 30/0202

(52) U.S. Cl. CPC G06Q 40/04; G06Q 30/0202

(57) ABSTRACT

In accordance with one or more embodiments, one or more apparatus is provided. A non-transitory storage may be provided that holds data concerning numerous foreign exchange trade transactions. A prophetic processing circuit may be provided that comprises at least one predictive model configured to predict, from the held data, upcoming foreign exchange trade transactions during a given future time period.

### FIELD OF THE DISCLOSURE

The present disclosure relates to information technology tools for managing foreign exchange transactions. More particularly, the present disclosure relates to information technology tools for aiding in planning and employing systems and human resources involved in foreign exchange transactions.

### BACKGROUND

Payment builder systems are used by intermediary institutions and others to aid in making and receiving payment transactions in foreign currencies in accordance with a strict process. This strict process involves contracts, funds availability, liquidity management, bank and interbank market communications, and currency transfers. These transactions follow a system of time cutoffs generally adhering to a “T+0 ” (same day) time window for the occurrence of all payments. Systems may be provided that are specific to teams of individuals, namely, maker, checker, and auditor teams.

The maker team initiates the transaction by splitting the payments and creating contracts for each beneficiary; the checker team reviews the information in the payments and the related documents and releases the payments to the beneficiaries by approving the transaction; and the auditor team reviews and revises (if necessary) contracts and other documents. This is a time and resource-consuming process generally, with substantially more demands on staff time and system resources when there is a split payment.

A split payment is a type of payment described in a single contract that contains more than one beneficiary. With better-advanced notice of predicted foreign exchange trade transactions, various problems may be mitigated. With more notice, various measures may be employed to ensure proper allocation and optimization of resources and to perform tasks ahead of time.

### SUMMARY

An objective of the present disclosure is to provide a system for predicting upcoming foreign exchange trade transactions, particularly upcoming split transactions.

These measures help ensure the optimized use of resources, for example, allowing advanced recruitment of high-quality systems and staffing and/or rescheduling of other activity to free up systems and staffing. In addition, these measures allow for various tasks to be performed ahead of time. With these benefits, errors will be prevented, and strict deadlines will be met.

For example, a given auto manufacturer may wish to make a payment for the purchase of several different commodities to multiple beneficiaries on a specified date that it requires to make automobiles. For these commodities, a single contract is celebrated. The payments are T+0 and will accordingly be conducted in a one-day coordinated operation. Therefore, for every split payment on the same day, a received contract will need to be canceled and replaced with a new contract for each beneficiary. Also, each stage of the entire foreign exchange process will need to be modified and multiplied to affect payments to all the beneficiaries.

One or more alternative or additional objectives may be served by the present disclosure, for example, as may be apparent in the following description.

Embodiments of the disclosure include any apparatus, machine, system, method, articles (e.g., computer-readable media encoded to cause certain acts), or any one or more sub-parts or sub-combinations of such apparatus (singular or plural), system, method, or article (or encoding thereon or therein), for example, as supported by the present disclosure. Embodiments herein also contemplate that any one or more processes as described herein may be incorporated into a processing circuit.

In accordance with one or more embodiments, one or more apparatus are provided. A non-transitory storage may be provided that holds data concerning numerous foreign exchange trade transactions. A prophetic processing circuit may be provided that comprises at least one predictive model configured to predict, from the held data, upcoming foreign exchange trade transactions during a given future time period.

The apparatus of any preceding clause may be modified such that the prediction includes a total amount of estimated liquidity for plural foreign exchange trade transactions predicted to occur during the given future time period.

The apparatus of any preceding clause may be modified such that the given future time period is a given month. The apparatus of any preceding clause may be modified such that the given future time period is on a specified date.

The apparatus of any preceding clause may be modified such that the predictive model is further configured to predict split payments expected to occur during the given future time period.

The apparatus of any preceding clause may be modified such that the predictive model is further configured to predict split payments for identified buyers on a specified date.

The apparatus of any preceding clause may be modified such that the predictive model is further configured to predict split payments for identified buyers for individual dates throughout a given time period.

The apparatus of any preceding clause may be modified such that the predictive model is further configured to predict an amount of estimated liquidity for a given split payment for an identified buyer on a given date.

The apparatus of any preceding clause may be modified such that the predictive model comprises a supervised machine learning (ML) processor.

The apparatus of any preceding clause may be modified such that the predictive model comprises a gradient boosting processor.

The apparatus of any preceding clause may be modified such that the predictive model comprises a light gradient boosting machine.

The apparatus of any preceding clause may be modified such that the predictive model comprises a time series forecasting processor.

The apparatus of any preceding clause may be modified such that the predictive model comprises an autoregressive integrated moving average model processor.

The apparatus of any preceding clause may be modified such that the held data includes, associated with individual transactions, features and feature values including a buyer identifier, currencies and amounts paid in the currencies, beneficiaries corresponding to the currencies and amounts paid in the currencies, a date on which the transaction occurred, liquidity required, and one or more cutoff times for payment to arrive in a beneficiary's account.

The apparatus of any preceding clause may be modified such that the held data includes key contract terms.

The apparatus of any preceding clause may be modified such that the held data includes one or more contracts.

The apparatus of any preceding clause may be modified such that the transactions include commodity trade transactions.

Another exemplary embodiment includes an exemplary method comprising holding, in a non-transitory storage, data concerning numerous foreign exchange trade transactions. In addition, the method comprises predicting, with at least one predictive model, from the held data, upcoming foreign exchange trade transactions during a given future time period.

Yet another exemplary embodiment provides a non-transitory computer-readable media encoded to cause holding, in a non-transitory storage, data concerning numerous foreign exchange trade transactions. In addition, the media is encoded to cause predicting, with at least one predictive model, from the held data, upcoming foreign exchange trade transactions during a given future time period.

Additional features, modes of operations, advantages, and other aspects of various embodiments are described below with reference to the accompanying drawings. It is noted that the present disclosure is not limited to the specific example embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an embodiment of a payment builder system;

FIG. 2 is a block diagram of an embodiment of an ML processor;

FIG. 3 is a flow chart of an embodiment of a post-prediction process carried out by the prophetic processing circuitry that may form part of the payment builder shown in FIG. 1;

FIG. 4 is a flow chart of a month-level predictive model process that may be carried out by the predictive model shown in FIG. 1 per one embodiment;

FIG. 5 is a flow chart of a date-specific predictive model process that may be carried out by the predictive model shown in FIG. 1 per another embodiment;

FIG. 6 is a flow chart of a process carried out to create a light gradient boosting machine per one embodiment of the predictive model shown in FIG. 1;

FIG. 7 is a flow chart carried out to create an autoregressive integrated moving average (ARIMA) model time series forecasting process per another embodiment of the predictive model shown in FIG. 1; and

FIG. 8 is a block diagram of an example computer controller.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

In the following, reference is made to example embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure.

Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim.

In accordance with one or more embodiments herein, various terms may be defined as follows.

Application or application program: An application program is a program that, when executed, performs a task for another program or user, whereas an operating system program, when executed, serves as an interface between an application program and the underlying hardware of a computer. Any one or more of the various acts described below may be carried out by a program, e.g., an application program and/or operating system program.

Attribute or feature: A variable, for example, a quantitative or qualitative characteristic of an item. As an example, “color” is a feature or an attribute, while “color is blue” is a feature value.
Feature value: A value or information of an attribute or feature.

Processing circuit: A processing circuit (or circuit) may include both (at least a portion of) non-transitory computer-readable media carrying functional encoded data and components of an operable computer. The operable computer is capable of executing (or is already executing) the functionally encoded data and, thereby, is configured when operable to cause certain acts to occur. A processing circuit may also include a machine or part of a machine that is specially configured to carry out a process, for example, any process described herein, or a special purpose computer or a part of a special purpose computer.

A processing circuit may also be in the form of a general-purpose computer running a compiled, interpretable, or compilable program (or part of such a program) that is combined with hardware carrying out a process or a set of processes. A processing circuit may further be implemented in the form of an application-specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.
Program: A program includes software for a processing circuit.

User interface tools; user interface elements; output user interface; input user interface; input/output user interface; and graphical user interface tools. User interface tools are human user interface elements that allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools).

Graphical user interface (GUI) tools, or graphical tools, include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data.

A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen-displayed icons, buttons, forms, or fields. Each time a user interfaces with a device, program, or system in the present disclosure, the interaction may involve any version of a user interface tool as described above, e.g., which may be a graphical user interface tool.

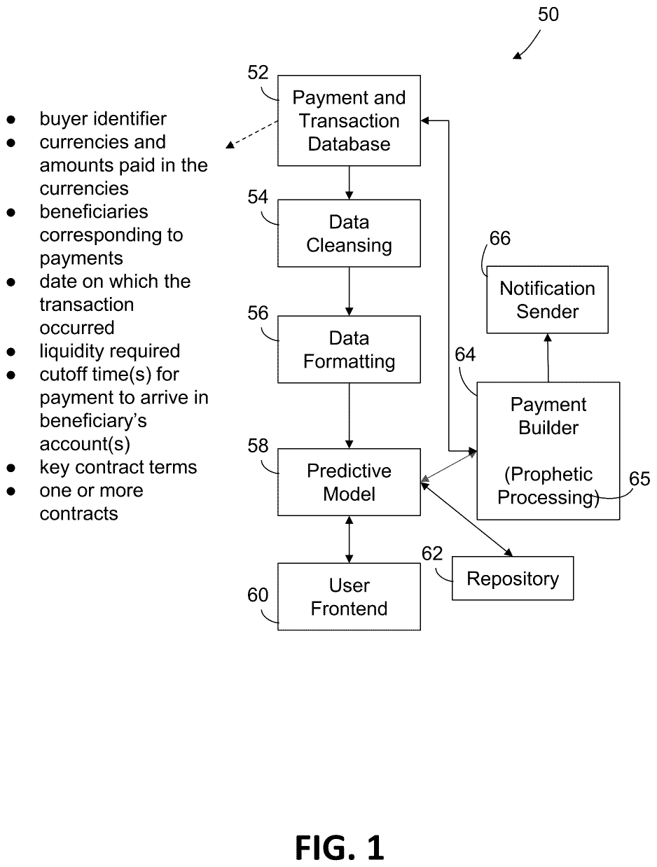

Referring to the drawings in further detail, FIG. 1 shows a block diagram of one embodiment of a payment builder system 50. The builder system 50 includes a payment builder 64. One non-limiting example of the payment builder 64 is the JP Morgan Chase Delivery versus Payment (DvP) system, or similar. The payment builder 64 is configured to present various UIs to users to carry out aspects of a foreign exchange trade transaction, for example, a commodity trade transaction. For example, the DvP application presents a Swift monitor to allow users to visualize payments made by clients and present information, including the contract, the customer, the currency, the date, the amount, the beneficiary, and the cut-off related to the payment.

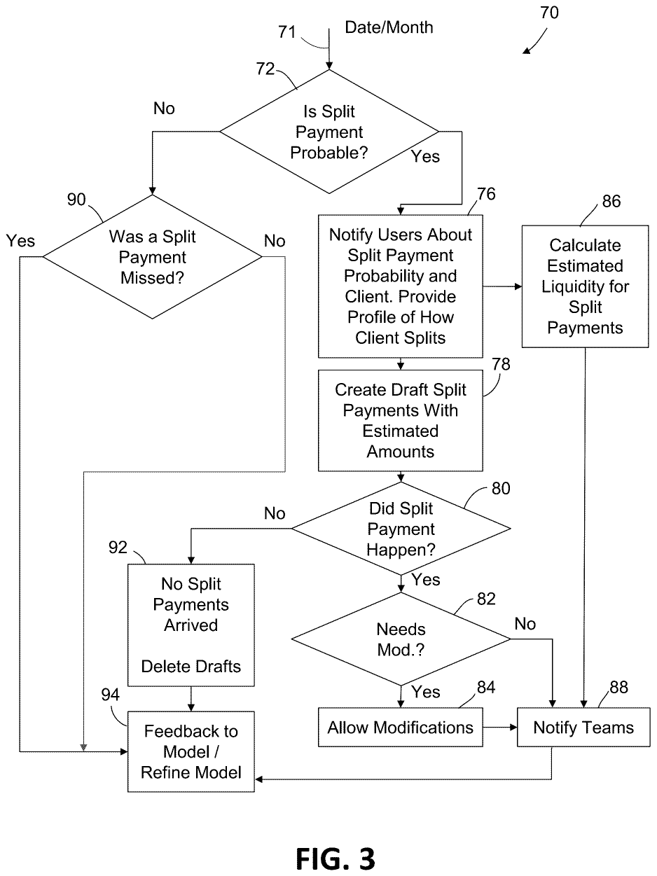

The builder system 50 shown in FIG. 1 is provided with a prophetic processing circuit 65 that may be supplemental to payment builder 64, or it may comprise a modified portion of payment builder 64. In the embodiment shown, the prophetic processing circuit 65 includes a predictive model 58 and is further configured to carry out post-prediction processing steps as further described below, for example, with reference to FIG. 3.

The builder system 50 also includes payment and transaction database 52, configured to hold data associated with individual transactions, features, and feature values including a buyer identifier, currencies and amounts paid in the currencies, beneficiaries corresponding to the currencies and amounts paid in the currencies, a date on which the transaction occurred, liquidity required, and one or more cutoff times for the payment to arrive in a beneficiary's account. The held data may further include key contract terms and one or more contracts.

Data cleansing processing circuit 54 is provided to sample feature sets from the payment and transaction database 52 and perform data cleansing on the sampled feature sets. The samples may be obtained using bootstrap sampling, as one example. As understood by those of skill in the art, bootstrap sampling is a statistical method used to estimate the distribution of a sample statistic by resampling with replacement from the original data. This technique allows for the creation of multiple simulated samples (called bootstrap samples) from a single dataset, enabling the estimation of the sampling distribution of a statistic without making strong assumptions about the form of the population distribution.

In the embodiments, the data is cleaned so that it is easily understood by either a human or a machine. This may be done using an automated process within processing circuit 54, may be done manually, or may use a combination of automated processing and human input.

Data formatting processing circuit 56 is provided to format the cleaned sampled data. The sampled feature sets are put into an interim format helpful to the model in ML processing that will be performed on the samples.

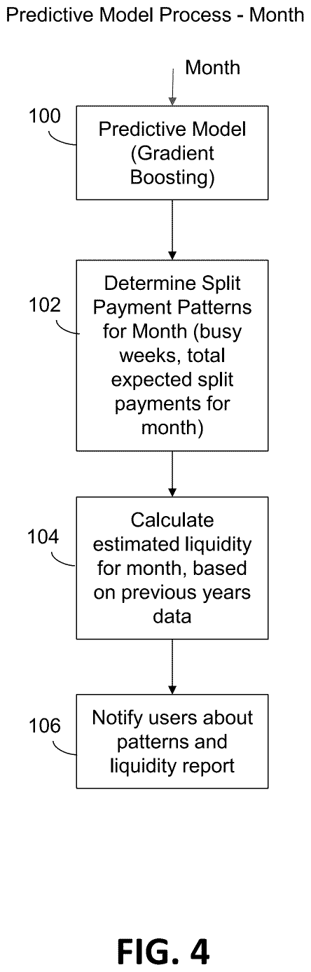

Predictive model 58 is configured to predict, from the held data, upcoming foreign exchange trade transactions during a selected future time period. Predictive model 58 may be configured to do either or both providing such predictions for a given month or for a specified date. The different approaches to these predictions per select embodiments will be described more fully below, for example, with reference to FIG. 4 (month-level prediction) and 5 (date-specific prediction).

The builder system 50 may be further provided with a user frontend 60. User frontend 60 may be provided with one or more user interface tools and associated applications, for example, for allowing a user to select a specific set of data for training or input to predictive model 58, or for allowing feedback or modifications to predictive model 58. Predictive model 58 may employ one or plural models, which may comprise ML algorithms. The individual or collective models may be used to employ predictive modeling for all modes, for example, for performing predictions over a month or on a specified date. Alternatively, separate models may be used for performing the predictions over a month than used for performing predictions for a specified date.

A repository 62 may be provided for holding prediction data output by predictive model 58. A notification sender 66 may be provided that is connected to payment builder 64, configured to send notifications, via messaging, email or another electronic messaging system, to team members.

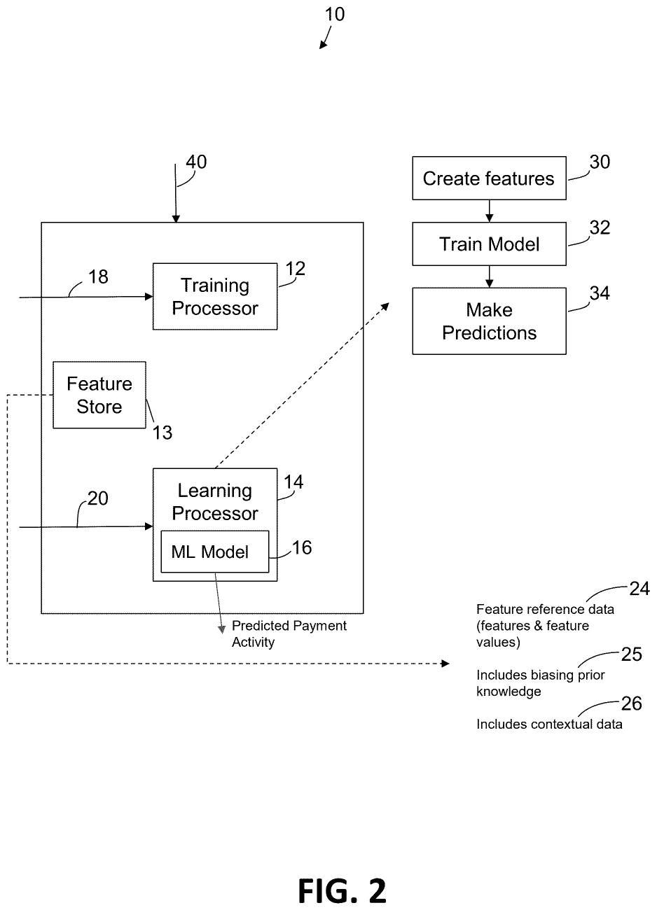

FIG. 2 shows a block diagram of an embodiment of an ML processor 10 which may be provided to carry out the predictive model 58 shown in FIG. 1. The ML processor 10 includes a training processor 12, a feature store 13, and a learning processor 14 including an ML model 16. Training data is input to training processor 12 via training data input 18, and prediction data is input to the learning processor 14 via prediction data input 20. Training processor 12 provides sample transaction data, labels, and associated data to the learning processor 14. The learning processor 14 provides as its output, for example, predictions of split payments.

As shown, feature store 13 may include feature reference data 24, which includes features and associated feature values, used for model training by training processor 12 and used for inferencing by learning processor 14. Feature store 13 may also include biasing prior knowledge 25 (for inductive bias employed by learning processor 14). This data may include live data, historical data, and/or contextual data. Feature store 13 may also include contextual data 26.

Learning processor 14 may be configured to carry out online or batch learning protocols, or a combination of the two. The training and learning by training processor 12 and learning processor 14 are performed pursuant to ML model 16. In operation, learning processor 14 carries out a process shown by blocks 30, 32, and 34, whereby features are created or populated from raw data at block 30, the model is trained at block 32, and predictions are made on new data at block 34.

Training may be supervised, where there is external (e.g., human) involvement to specify labels associated with input sample messages. Alternatively, training may be unsupervised, where labels are provided automatically, and training occurs without external input.

Model 16 may comprise one or more decision trees or other specific algorithms as described below, for example, with references to FIGS. 4-7.

In these embodiments of ML processor 10, sample transactions input to training processor and output predicted transactions have a number of accompanying features. As one example, those features may include all or any subset of the following:
a) F1. Split payment or no split payment.
b) F2. Amount of beneficiaries.
c) F3. Client/buyer.
d) F4. Currencies and amounts.
e) F5. Date of transaction.
f) F6. Beneficiaries.

### G) F7. Cutoff for Payment.

A transaction validation input 40 may be provided whereby model feedback information from a transaction validation portion is input to ML processor 10. For example model feedback may be provided when, in the post-prediction processing shown in FIG. 3, a split payment was predicted as determined at step 72 and missed or not missed as determined at step 90. As a result of the feedback via the transaction validation input 40, the model 16 may be refined.

FIG. 3 is a flow chart illustrating an exemplary post-prediction process 70 that may be performed by the prophetic processing circuit 65 shown in FIG. 1 and described above. When predictive model 58 has made a split payment prediction at step 71 for a given future time period, such as a specific date or for a particular month, the process 70 proceeds to step 72. At step 72, the process 70 determines if one or more split payments are probable (predicted by predictive model 58).

If split payments are probable, then for each predicted split payment and associated predicted client, at step 76, users (team members as described above) are notified, for example, with a report, screen, or direct message about details of the predicted split payment and the anticipated client. These details may include profile information about how the anticipated client typically splits.

In an example embodiment, the profile information about how a given client will be expected to split for a given predicted split may contain one or more of the following features and feature values related to fund availability and location, currency types, steps of the transaction, and cutoff times:
a) Payment order at origin bank (e.g., FCCY-1st Constitution Bancorp in U.S.)
b) Activity at origin bank associated with the payment order
   (i) Funds available in origin currency (e.g., USD) in origin account and associated cutoff time (e.g., 18:20 N.Y. time zone)
   (ii) If applicable, transfer of the available funds to another account in the same institution, and cutoff time for same (e.g., USD, BOOK TRANSFER, 19:30 NY)
   (iii) Funds made available, at the same origin bank, in various different currencies associated with the typical beneficiaries for a split payment for the current client, with specified respective cutoff times. The beneficiaries may also be specified (e.g., EUR/GBP (Euro to Pound rate) at 00:30 UK (United Kingdom), CHF (Swiss Francs) at 00:30 UK, NDK (Norwegian Kroner) at 00:30 UK, SEK (Swedish Krona) at 00:30, and JPY (Japanese Yen) wired the day before (T−1)).
c) Activity at other institutions for registration (e.g., at BACEN-Central Bank of Brazil)
   (i) registration at a foreign exchange bank (e.g., BACEN) with cutoff time (e.g., cutoff range of 9:00-19:00 Sao Paolo; different cutoff ranges may be provided for different geopolitical events such as the pandemic)
   (ii) liquidation and liquidation bank (e.g., BACEN) with cutoff time (e.g., cutoff range of 7:00-20: 20 Sao Paolo; different cutoff ranges may be provided for different geopolitical events such as the pandemic)
   (iii) registration at The Interbank Market with cutoff time and range of time during which demand will not increase (D+0).
d) Payment and receipt at destination banks in destination currencies (following examples given for one beneficiary in Brazil; other beneficiaries would also be specified depending on the split) (e.g., BRL at BACEN)
   (i) electronic transfer issuance available at cutoff time (e.g., 17:30 Sao Paulo).
   (ii) transfer between institutions at cutoff time (e.g., 18:30 Sao Paulo).
   (iii) funds available in beneficiary current accounts at cutoff time (e.g., 20:00 Sao Paulo).

At step 78, draft split payments are created with estimated amounts, based on the information determined at step 76.

At step 80, the process 70 determines whether a split payment happened during the given future time period of interest, e.g., on the specified date or during the month. Then, at step 82, for those splits that were predicted (per step 72) and occurred (per step 80), a determination is made whether the split, as it actually occurred, required modification to one or more parameters of the transaction, at step 82. If modifications were needed, at step 84 those modifications are allowed, and the process 70 proceeds to step 88. At step 88, the teams are notified regarding the various information determined throughout process 70 up to this point. If the modifications were not needed, as determined at step 82, the process 70 proceeds to step 88.

When a predicted split did not happen as determined at step 80, the process proceeds to step 92 at which point information is stored and/or communicated, for example, to team members, indicating that no split payments arrived, and drafts for the predicted split are deleted. The Process then proceeds from step 92 to step 94, where feedback is provided to the model and/or the model is refined.

The process 70 also proceeds from step 76 to step 86, at which point the estimated liquidity for the split payments for each expected split and associated client is estimated. This information is subsequently provided to the teams, at step 88.

If a split is not probable, as determined at step 72, the process 70 proceeds to step 90, where a determination is made as to whether a split payment was missed by the predictive model 58 in FIG. 1. With either result, the process 70 proceeds to step 94, at which point feedback is sent to the model, and/or the model is refined.

Any time the teams are notified at step 88, the process 70 may proceed to step 94, for feedback and/or refinement based on the information for which the teams were notified.

FIG. 4 shows a flow chart of one embodiment of a month level predictive model process (e.g., the predictive model 58 of FIG. 1) that may be performed by the prophetic processing circuit 65 shown in FIG. 1.

For a given month, at step 100, predictive model 58 predicts, among other things, whether and the extent to which there will be split payments during the month. In one embodiment, the predictive modeling in step 100 may involve gradient boosting, for example, as further described below. In alternative embodiments, the predictive modeling in step 100 may involve a light gradient boosting machine, extreme gradient boosting, or a gradient boosting regressor.

At step 102, split payments for the month are determined. This information may further include data identifying busy weeks and a total expected amount of split payments for the month. At step 104, the estimated liquidity required for the month's transactions is calculated. This estimate may be for just the split payments transactions, and/or a calculation may be made of the estimated liquidity required for all transactions. These calculations are made based on previous data provided, for example, in the payment and transaction database 52 shown in FIG. 1. At step 106, users (team members) are notified about the determined patterns and also provided with a liquidity report.

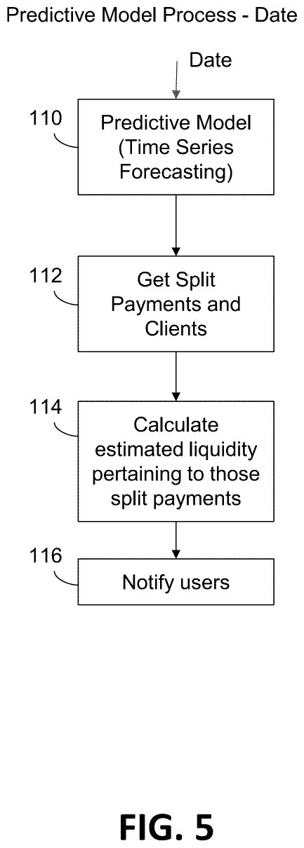

FIG. 5 shows a flow chart of one embodiment of a date specific predictive model process that may be performed by the prophetic processing circuit 65 shown in FIG. 1.

For a specified date, at step 110, predictive model 58 carries out a predictive modeling process to provide at step 112 split payments expected to occur on that day along with associated client buyers for which those payments may be made. In one embodiment, the predictive model at step 110 includes a time series forecasting, for example, as further described below. Per alternative embodiments, the model may include a time series forecasting model using an ARIMA model, a seasonal integrated moving average (SARIMA) model, an open-source model (e.g., Prophet provided by Facebook's Prophet Python Library), or other exemplary models (e.g., GluonTS model from Amazon's GluonTS Python Library).

At step 114, a calculation is performed to determine the estimated liquidity for each of the predicted split payments. At step 116, users are notified of the results.

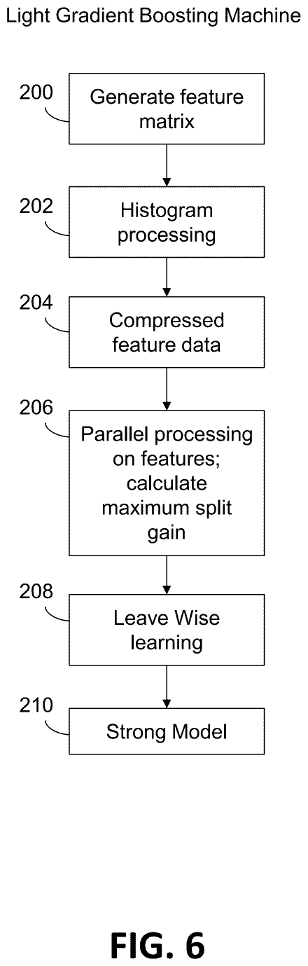

FIG. 6 is a flow chart of a process for creating a light gradient boosting machine, for use as an embodiment of the predictive model 58 in FIG. 1. More specifically, the resulting light gradient boosting machine may be an embodiment for carrying out the predictive model step 100 in FIG. 4.

Generally, a light gradient boosting machine (LightGBM) combines aspects from gradient-based side sampling and exclusive feature bundling (EFB). In step 200, a feature matrix is generated. At step 202, histogram processing is performed on the data in the feature matrix to reduce the number of data instances and the number of features, creating compressed feature data at step 204.

In the histogram pre-processing step 202, a histogram algorithm separates continuous data into a set of K-integers and creates a K-width histogram. The histogram is used to determine and search for the best decision tree split point.

At step 206, parallel processing is performed on the features across a set of weak regression trees, and a leaf with a maximum split gain is determined for each leaf. Then at step 208, leaf wise learning, otherwise called leaf-wise tree growth, is conducted, to create at step 210 a strong model

Per alternative embodiments of the predictive model in step 100 in FIG. 4. Recurrent neural networks (RNNs) of Gated Recurrent Units (GRUs) or Long Short-Term Memory (LSTM) units may be used.

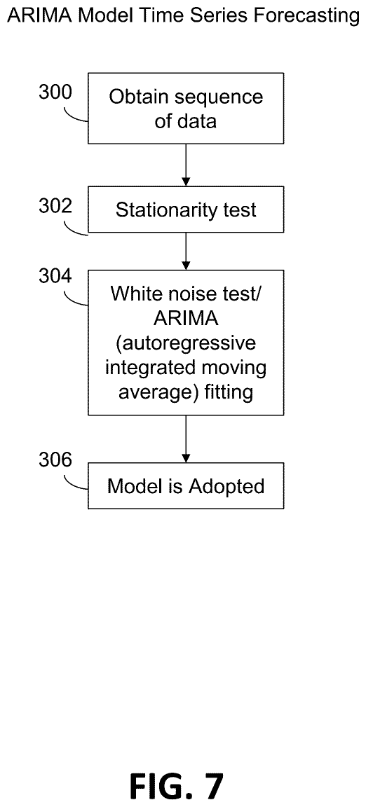

FIG. 7 is a flow chart of a process for creating the ARIMA model, for use as an embodiment of the predictive model 58 in FIG. 1. More specifically, the resulting ARIMA model may be an embodiment for carrying out the predictive model step 100 in FIG. 5.

At step 300, a sequence of data is obtained. Next, at step 302, a stationarity test is performed. At step 304, a white noise test and ARIMA fitting are performed. At step 306, an ARIMA model is adopted.

Alternative models that can be implemented instead of ARIMA at step 304, are Informer and Prophet. These ones are implementations of time series transformers which could prove to be a more effective embodiment of the predictive model 58 in FIG. 1.

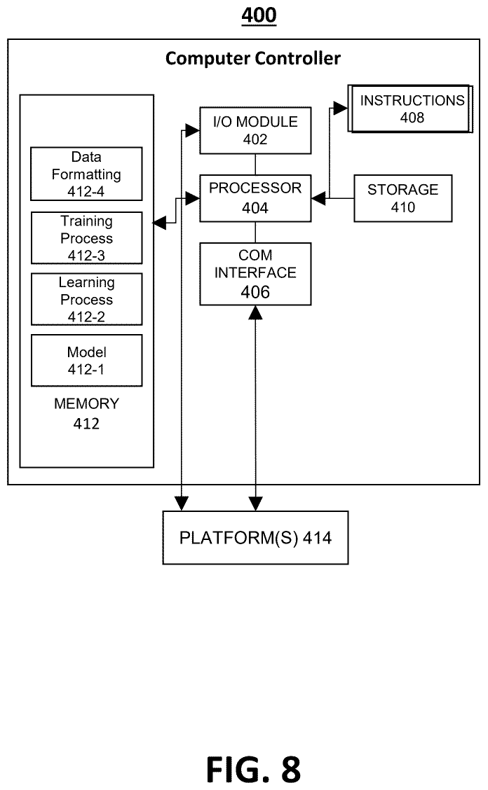

FIG. 8 illustrates a computer controller 400 that may be an application-specific hardware, software, and firmware implementation of the payment builder system 10 in FIG. 1, described above. The controller 400 may include a processor 404 configured to be executed on one or more, or all of the blocks of the system of FIG. 1, or the functions of the builder system 50, described above.

The processor 404 can have a specific structure imparted to the processor 404 by instructions stored in the memory 412 and/or by instructions 408 fetchable by the processor 404 from a storage medium 410. The storage medium 410 can be remote and communicatively coupled to the controller 400.

The controller 400 can be a stand-alone programmable system, or a programmable module included in a larger system. For example, the controller 400 may include or be connected with the payment builder system 50. For example, the controller 400 may include one or more hardware and/or software components configured to fetch, decode, execute, store, analyze, distribute, evaluate, and/or categorize information.

The processor 404 may include one or more processing devices or cores (not shown). In some embodiments, the processor 404 may be a plurality of processors, each having one or more cores. The processor 404, in another embodiment, may be a distributed processor. The processor 404 can execute instructions fetched from the memory 412, i.e., with reference to, among other code, instructions or data, one of memory modules 412-1, 412-2, 412-3, or 412-4.

Alternatively, the instructions can be fetched from the storage medium 410, or from a remote device connected to the controller 400 via the communication interface 406. Furthermore, the communication interface 406 can also interface with computer systems within a computer system of the builder system 50. An input/output (I/O) module 402 may be configured for additional communications to or from associated local and/or remote systems of one or more platforms 414 of builder system 50.

Without loss of generality, the storage medium 410 and/or the memory 412 can include a volatile or non-volatile, magnetic, semiconductor, tape, optical, removable, non-removable, read-only, random-access, or any type of non-transitory computer-readable computer medium. The storage medium 410 and/or the memory 412 may include programs and/or other information usable by processor 404. Furthermore, the storage medium 410 can be configured to log data processed, recorded, or collected during the operation of controller 400.

The data may be time-stamped, location-stamped, cataloged, indexed, encrypted, and/or organized in a variety of ways consistent with data storage practice. The memory modules in memory 412 may represent specialized modules for various functions described in the embodiments herein. By way of example, the memory module 412-1 may represent a specialized module configured to implement aspects of one or more of the models described above.

Similarly, the memory module 412-2 may form a specialized learning processor module as described above with reference to FIG. 2, the memory module 412-3 may form a specialized training process module as described above with reference to FIG. 2, and the memory module 412-4 may form a specialized data formatting module. The instructions embodied in these memory modules can cause the processor 404 to perform certain operations consistent with the functions described above.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

1. Apparatus comprising:
a non-transitory storage that holds data concerning numerous foreign exchange trade transactions;
a payment processing system that includes a processing circuit that comprises at least one predictive model configured to predict, from the held data, upcoming foreign exchange trade transactions during a selected future time period; and
a data cleansing processing circuit being configured to sample feature sets from a payment and transaction database and perform data cleansing on the sampled feature sets;
wherein, in response to the at least one predictive model indicating a probability of a split payment exceeding a threshold, the processing circuit is further configured to:
generate draft split-payment instructions specifying plural beneficiaries, payment amounts, and settlement cutoff times;
estimate liquidity required to execute the draft split-payment instructions;
notify users regarding details of predicted split payments and anticipated clients,
determine whether modifications to one or more transaction parameters are required
and
selectively transmit, modify, or delete the draft split-payment instructions based on observed settlement outcomes.

2. The apparatus according to claim 1, wherein the held data includes, associated with individual transactions, features and feature values including a buyer identifier, currencies and amounts paid in the currencies, beneficiaries corresponding to the currencies and amounts paid in the currencies, a date on which the transaction occurred, liquidity required, and one or more cutoff times for payment to arrive in a beneficiary's account. Response to Office Action

3. The apparatus according to claim 2, wherein the prediction includes a total amount of estimated liquidity for plural foreign exchange trade transactions predicted to occur during the given future time period.

4. The apparatus according to claim 2, wherein the given future time period is a given month.

5. The apparatus according to claim 2, wherein the given future time period is limited to a specified date.

6. The apparatus according to claim 2, wherein the predictive model is further configured to predict split payments expected to occur during the given future time period.

7. The apparatus according to claim 2, wherein the predictive model is further configured to predict split payments for identified buyers on a specified date.

8. The apparatus according to claim 7, wherein the predictive model is further configured to predict split payments for identified buyers for individual dates throughout a given time period.

9. The apparatus according to claim 7, the predictive model is further configured to predict an amount of estimated liquidity for a given split payment for an identified buyer on a given date.

10. The apparatus according to claim 2, wherein the predictive model comprises a supervised ML processor.

11. The apparatus according to claim 10, wherein the predictive model comprises a gradient boosting processor.

12. The apparatus according to claim 11, wherein the predictive model comprises a light gradient boosting machine.

13. The apparatus according to claim 2, wherein the predictive model comprises a time series forecasting processor.

14. The apparatus according to claim 10, wherein the predictive model comprises a time series forecasting processor.

15. The apparatus according to claim 13, wherein the predictive model comprises an autoregressive integrated moving average model processor.

16. The apparatus according to claim 2, wherein the held data includes key contract terms.

17. The apparatus according to claim 2, wherein the held data includes one or more contracts.

18. The apparatus according to claim 2, wherein the transactions include commodity trade transactions.

19. A method comprising:
holding, in a non-transitory storage, data concerning numerous foreign exchange trade transactions;
predicting, with at least one predictive model, from the held data, upcoming foreign exchange trade transactions during a given future time period; and
in response to predicting a probability of a split payment exceeding a threshold:
(1) generating draft split-payment instructions specifying one or more beneficiaries, payment amounts, and settlement cutoff times;
(2) estimating liquidity required to execute the draft split-payment instructions; and
(3) selectively transmitting, modifying, or deleting the draft split-payment instructions based on observed settlement outcomes.

20. A non-transitory computer-readable media, executable by a processor, encoded to cause the processor:
in connection with data held in a non-transitory storage, the data concerning numerous foreign exchange trade transactions; and
to predict with at least one predictive model, from the held data, upcoming foreign exchange trade transactions during a given future time period; and
in response to predicting a probability of a split payment exceeding a threshold,
(1) generate draft split-payment instructions specifying plural beneficiaries, payment amounts, and settlement cutoff times;
(2) estimate liquidity required to execute the draft split-payment instructions; and
(3) selectively transmit, modify, or delete the draft split-payment instructions based on observed settlement outcomes.
